(19) United States
(12) Patent Application Publication
(10) Pub. No.: US 2010/0239719 A1
(43) Pub. Date: Sep. 23, 2010

(54) Pizza With Peripheral Crust Structure

(76) Inventor: Kevin P. Matthews, Dayton, OH (US)

Correspondence Address: THOMPSON HINE L.L.P.;Intellectual Property Group, P.O. BOX 8801, DAYTON, OH, 45401-8801, US

(21) Appl. No.: 12/409,144

(22) Filed: Mar. 23, 2009

(51) Int. Cl. A21D 2/00

(52) U.S. Cl. 426/94

(57) ABSTRACT

A pizza including a dough substrate defining a plurality of pieces, each piece including a sheet portion bounded by at least two internal edges and at least one external edge, wherein at least a portion of each of the internal and external edges includes a crust portion, the crust portion having a thickness that is different than a thickness of the sheet portion, and at least one topping disposed on the sheet portion.

### BACKGROUND

The present disclosure is generally directed to pizza and, more particularly, to pizza dividable into a number of pieces, wherein each piece of the pizza has crust along at least a part of each peripheral edge.

Pizza is a widely popular food item in the United States and around the world. By combining ingredients from the various food groups, including bread, cheeses, meats and vegetables, pizza has become a quick, easy and nutritious meal that can be consumed at home, in restaurants or pizzerias, and on the go.

Referring to FIGS. 1 and 2, a typical pizza, generally designated 10, includes a dough substrate 12 and one or more toppings 14 positioned over the dough substrate. The dough substrate 12 is typically formed into a generally flat sheet 16 having a crust portion 18 extending about the periphery of the sheet. As shown in FIG. 2, the crust portion 18 may be elevated relative to the sheet portion 16 to form a raised crust, similar to a traditional pie; hence the common reference to pizza as a “pizza pie.” The sheet 16 and the crust portion 18 define a surface or recess 20 for receiving the toppings 14. The assembled pizza 10 is typically baked before serving.

After baking, the pizza 10 is typically divided into a number of individual pieces 22A, 22B, 22C, 22D, 22E, 22F, 22G, 22H (collectively, pieces 22). The pieces 22 may be formed by cutting the pizza 10 into pie-shaped wedges, as shown in FIG. 1, or otherwise. Nonetheless, regardless of how the pizza 10 is cut, the amount of the crust portion 18 on each piece 22 is limited to the crust portion 18 along the original peripheral edge of the sheet 16 or, in some case, depending on how the pizza was cut, may not have any exposed crust whatsoever.

The crust portion 18 of the pizza 10 is often the portion of the pizza that is most desired by certain consumers. Furthermore, the crust portion 18 of the pizza 10 often provides a useful function. For example, the crust portion 18 on a piece 22 of pizza 10 is often used by consumers to hold the piece of pizza without contacting the toppings 14. Furthermore, the crust portion 18, particularly a raised crust portion, provides a certain structural stability to the piece 22 of pizza, thereby making it easier to hold and consume

Accordingly, it would be desirable to increase the amount of crust on a pizza. In particular, it would be desirable to provide a pizza wherein each piece of the pizza has crust along at least a part of each of the peripheral edges thereof.

### SUMMARY

In one aspect, the disclosed pizza may include a dough substrate defining a plurality of pieces wherein each piece of the plurality of pieces defines a perimeter and includes a sheet portion and a crust portion, the perimeter comprising one or more exterior edges and one or more interior edges, wherein the one or more exterior edges and the one or more interior edges include the crust portion partially thereon, and, optionally, at least one topping positioned on said dough substrate.

In another aspect, the disclosed pizza may include a dough substrate defining a plurality of pieces, each piece including a sheet portion bounded by at least two internal edges and at least one external edge, wherein at least a portion of each of the internal and external edges includes a crust portion, the crust portion having a thickness that is different (e.g., greater) than a thickness of the sheet portion, and, optionally, at least one topping disposed on the sheet portion.

In another aspect, the disclosed pizza may include a dough substrate defining at least three pieces, each of said pieces being at least partially separated by associated cut lines formed in the dough substrate, wherein each of the pieces includes a sheet portion bounded by at least three edges, wherein at least one of the edges is an exterior edge and includes an associated crust portion substantially entirely thereon and at least two of the edges are interior edges and include an associated crust portion at least partially thereon, wherein the crust portion has a thickness that is different (e.g., greater) than a thickness of the sheet portion, and at least one topping layered over the sheet portion of the dough substrate.

In another aspect, the disclosed method for forming a pizza may include the steps of providing a quantity of dough and at least one topping, forming the dough into a substrate defining at least three pieces wherein each of the pieces includes a perimeter, a sheet portion and a crust portion, the perimeter comprising one or more exterior edges and one or more interior edges, wherein the one or more exterior edges includes the crust portion substantially entirely thereon, and the one or more interior edges includes the crust portion partially thereon, and applying the topping to the sheet portion of the substrate.

Other aspects of the disclosed pizza and associated methods and apparatus for forming the same will become apparent from the following description, the accompanying drawings and the appended claims.

### BRIEF DESCRIPTION OF THE DRAWINGS

FIG. 1 is a top plan view of a prior art pizza;

FIG. 2 is a cross-sectional view of the pizza of FIG. 1, taken along line A-A;

FIG. 3 is a front elevational view of one aspect of the disclosed assembly for forming a pizza;

FIG. 4 is atop plan view of a pizza-forming die of the assembly of FIG. 3;

FIG. 5 is a front perspective view of one aspect of the disclosed pizza, the pizza including a dough substrate and toppings;

FIG. 6 is a top plan view of the dough substrate of the pizza of FIG. 5, the dough substrate defining a number of pieces;

FIG. 7 is a top plan view of a piece removed from the dough substrate of FIG. 6;

FIG. 8 is a cross-sectional view of the dough substrate of FIG. 6, taken along line B-B;

FIG. 9 is a cross-sectional view of the dough substrate of FIG. 6, taken along line C-C;

FIG. 10 is a perspective view of an alternative aspect of the disclosed pizza; and

FIG. 11 is a top plan view of the pizza of FIG. 10.

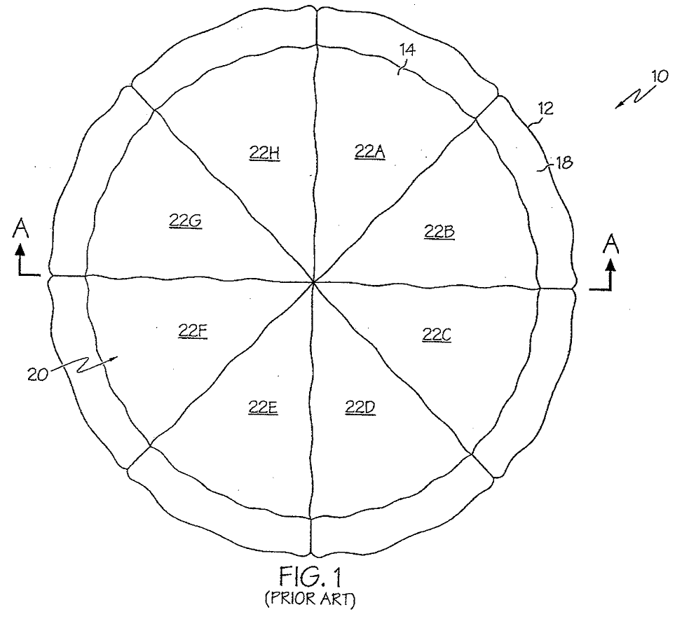

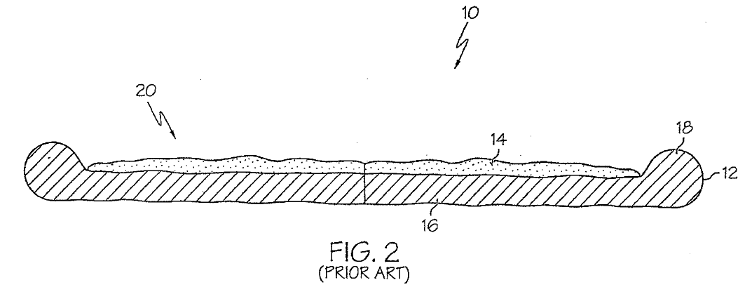

### DETAILED DESCRIPTION

As used herein, the term “central region” of a pizza is defined as a variably-sized area adjacent to and radiating outward from a center point of the pizza pie and substantially terminating at the endpoints of the interior edges of the pizza pie.

As used herein, the term “center point” of a pizza is defined as the point where two perpendicular lines drawn through the center of a dough substrate of a pizza intersect. For example, in a generally circular pizza, the “center point” is defined as the point where two diametrical lines drawn across the dough substrate intersect.

As used herein, the term “edge” of a piece of pizza is defined as a section that defines a portion of the outer perimeter of a piece of pizza, and may be straight, curved or irregular. Each piece of a multi-piece pizza will have a plurality of edges. The edge may be an actual edge that is formed by cutting the pizza into pieces or, alternatively, may be an intended edge defined, at least partially, by crust structure and/or pre-formed cut lines (e.g., perforations) that guide the user.

As used herein, the term “interior” is defined as being a portion of a pizza (or a piece of pizza) that is disposed within the outer perimeter of the pizza.

As used herein, the term “exterior” is defined as a portion of a pizza (or piece of pizza) that is disposed along the outer perimeter of the pizza.

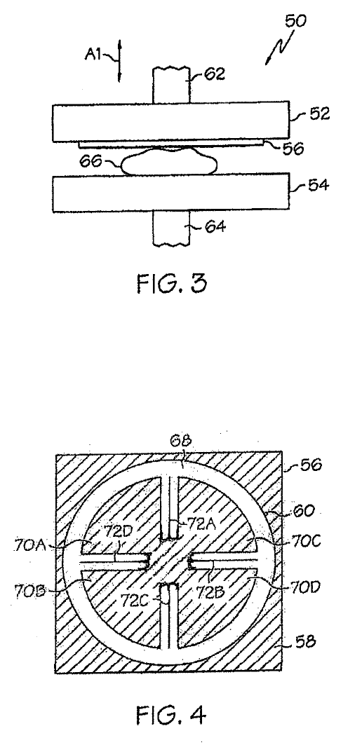

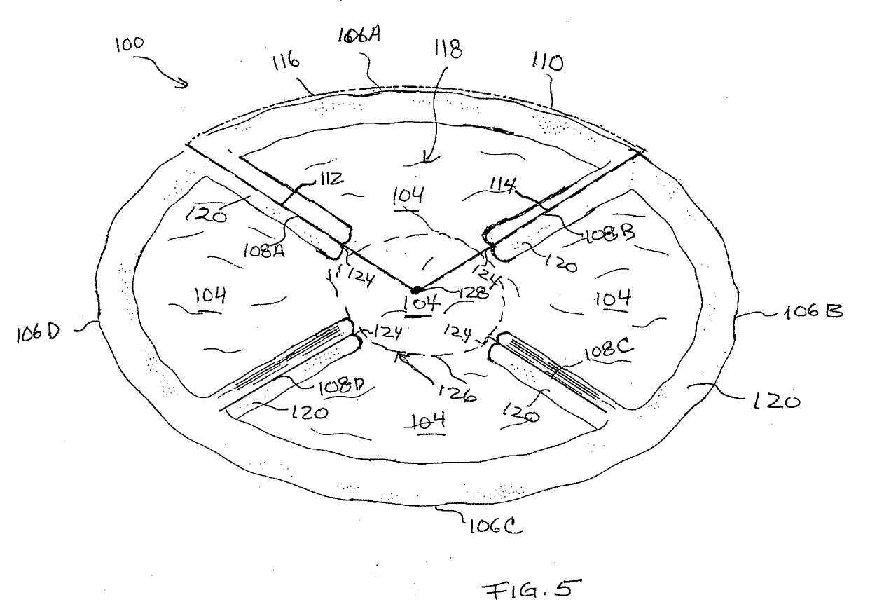

Referring to FIG. 3, one aspect of the disclosed assembly for forming a pizza dough substrate, generally designated 50, may include a first platen 52, a second platen 54 and a die 56. The die 56 may be connected to the first platen 52. Optionally, a second, corresponding die may be connected to the second platen 54. As shown in FIG. 4, the die 56 may have a surface 58 in which is formed a recessed mold cavity 60. The mold cavity 60 may be shaped to form a dough substrate to have the features described in greater detail below.

Referring again to FIG. 3, the first platen 52 may be connected to a first support member 62 and the second platen 54 may be connected to a second support member 64. The first support member 62 and associated first platen 52 and die 56 may be moveable relative to the second platen 54 in the direction shown by arrow A1 to bring the die 56 into engagement and disengagement with the second platen 54.

Thus, the assembly 50 may be used to form a pizza dough substrate as follows. First, a portion of pizza dough 66 may be positioned on the second platen 54. If a second die (not shown) is used, the pizza dough 66 may be positioned in the second die. Then, the first platen 52 may be advanced into engagement with the second platen 54 such that the die 56 engages the pizza dough 66 and forms the desired pizza dough substrate. Finally, the first platen 52 may be disengaged from the second platen 54 and the newly formed pizza dough substrate may be removed from the assembly 50. Optionally, a lubricating substance, such as oil, flour, cornmeal or the like, may be applied to the die 56 and/or second platen 54 to limit the amount of pizza dough 66 that sticks to the assembly 50.

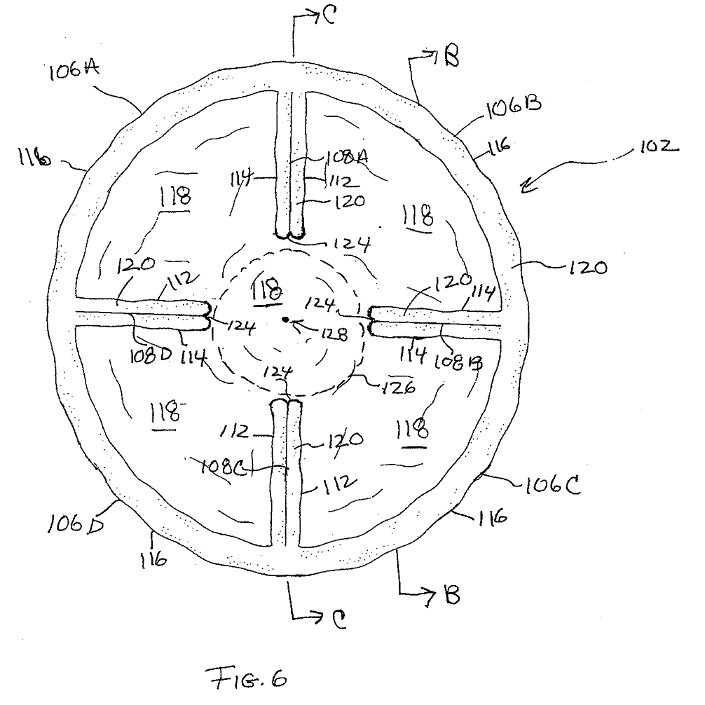

Referring to FIG. 5, one aspect of the disclosed pizza, generally designated 100, may include a pizza dough substrate 102 and one or more toppings 104. The dough substrate 102 may be formed from any appropriate dough. In one aspect, the dough substrate 102 may be formed from a dough that rises due to yeast and yields a soft, chewy texture after baking. In another aspect, the dough substrate 102 may be formed from a dough that yields a thin and crispy or cracker-like texture after baking. For example, a traditional pizza dough may be formed from a rising dough that may include, among other things, flour (e.g., all purpose flour), water (typically warm water), yeast, oil (e.g., olive oil) and salt. Optional dough ingredients include seasonings, spices, cheeses, sugar and honey.

The toppings 104 may be layered over the dough substrate 102, whether before, during or after baking. While the choice of toppings 104 is purely a matter of personal preference, typical toppings include sauces, cheeses, meats, seafood and produce. Examples of sauce toppings include tomato-based sauces, pesto-type sauces, white sauces and the like. Examples of cheese toppings include mozzarella, provolone, parmesan and the like. Examples of meat toppings include pepperoni, sausage, ham, bacon and the like. Examples of seafood toppings include anchovies, shrimp, smoked salmon and the like. Examples of produce toppings include peppers, onions, basil, mushrooms, pineapple and the like.

The pizza 100 may be prepared as a traditional pizza by (1) forming the dough substrate 102, (2) layering toppings 104 over the dough substrate 102 as follows: a layer of tomato-based sauce (e.g., marinara sauce) over the dough substrate 102 and a layer of melting cheese (e.g., mozzarella) over the tomato-based sauce, and (3) baking the pizza 100 until the dough substrate 102 and the toppings 104 achieve the desired texture. However, those skilled in the art will appreciate that the disclosed pizza 100 may be prepared and/or sold in any form, such as a ready-to-bake refrigerated pizza, a frozen pizza or the like.

Referring to FIG. 6, one aspect of the disclosed pizza dough substrate 102 may be generally round or circular in top view and may define four segments or pieces 106A, 106B, 106C, 106D (collectively, pieces 106). A center point 128 of the dough substrate 102 may be defined as the point where two diametrical lines drawn across the dough substrate intersect. Those skilled in the art will appreciate that the number of pieces 106 defined by the dough substrate 102 is purely a matter of design and that the dough substrate 102 may be formed to define any number of pieces 106 (e.g., 2 pieces, 5 pieces or 8 pieces). Optionally, as shown in FIG. 6, the pieces 106 may be at least partially defined by pre-formed cut lines 108A, 108B, 108C, 108D, such as perforations, which may be formed when the dough substrate 102 is formed (e.g., using the assembly 50 disclosed above). However, absent pre-formed cut lines to define the individual pieces, the pieces 106 may be at least partially defined by the crust portion 120 discussed in greater detail below. Alternatively, the pieces 106 may be defined by actual cuts in the pizza 100.

Referring to FIG. 5, and using piece 106A as an example, each piece 106 defined by the dough substrate 102 has a defined perimeter 110, which is shown as a solid, bold outline about the periphery of piece 106A. Since the pizza 100 shown in FIG. 5 is generally circular in top view and since the dough substrate 102 defines wedge-shaped pieces 106, the perimeter 110 of piece 106A may include two interior edges, shown as a first straight edge 112 and a second straight edge 114, and an exterior edge, shown as a curved edge 116. However, the shape of the perimeter 110 of each piece 106 is dependent upon the shape of each piece 106 and/or the shape of the overall pizza 100.

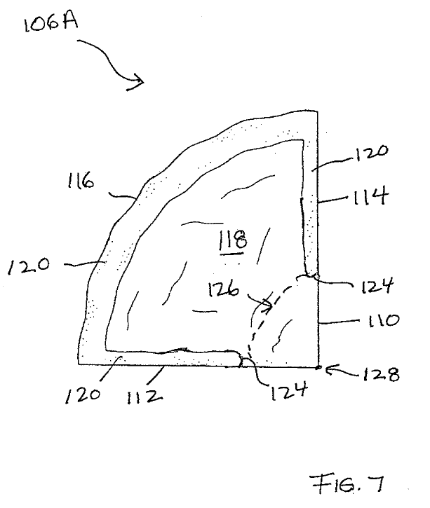

Referring back to FIG. 6, each piece 106 defined by the dough substrate 102 may include a sheet portion 118 and a crust portion 120. As best shown in FIG. 7, the crust portion 120 may extend substantially entirely along the curved edge 116 of the perimeter 110 of each piece 106. However, those skilled in the art will appreciate that the pizza 100 may be configured such that only a portion of the curved edge 116 includes crust portion 120. The crust portion 120 along the curved edge 116 of the perimeter 110 may further extend inwardly along at least a part of the first and second straight edges 112, 114 of each piece 106. The point at which the crust portion 120 ends along the first and second interior straight edges 116, 118 defines an endpoint 124 of the crust portion 120. In other words, each piece 106A, 106B, 106C, 106D, when removed from the other pieces 106, may include a crust portion 120 along the curved edge 116, as is common with prior art pizzas, as well as a crust portion along at least a portion of the first and second straight edges 112, 114.

In one aspect, the length of the crust portion 120 on the first and second straight edges 112, 114 may be less than the length of a line drawn from the curved edge 116 to the center point 128 of the dough substrate 102. As best shown in FIG. 5, a central region 126 of the dough substrate 102 adjacent to the center point 128 of the dough substrate 102 may be substantially free of the crust portion 120. The size of the central region 126 surrounding the center point 128 of the pizza 100 may be varied by changing the shape of the mold cavity 60 of the disclosed assembly 50 (FIG. 3), which in turn changes the length of the crust portion 120 along the first and second straight edges 112, 114 of each piece 106.

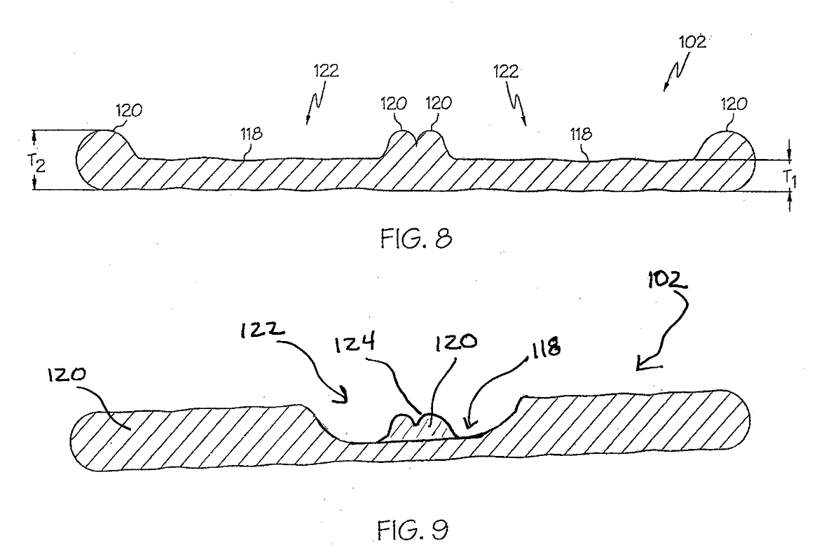

The sheet portion 118 of the dough substrate 102 may receive the toppings 104, as shown in FIG. 5. Optionally, the sheet portion 118 of one or more of the pieces 106 may have toppings 104 that are different than the toppings 104 on the sheet portion 118 of the other pieces 106. The sheet portion 118 may be generally flat such that toppings 104 applied to the sheet portion 118 do not slide or move. The thickness T₁ (FIG. 8) of the sheet portion 118 may depend upon the type of dough being used and is generally a matter of person preference. However, the thickness T₁ should be sufficiently high to maintain structural integrity after toppings 104 have been applied.

The crust portion 120 may extend at least partially along the periphery of the sheet portion 118 such that each piece 106 at least partially includes the crust portion 120 along the perimeter 110 thereof. In one aspect, the crust portion 120 may be the portion of the dough substrate 102 upon which different, fewer or no toppings 104 are applied. However, the crust portion 120 may be distinguishable from the sheet portion 118 by any available means. In another aspect, as best shown in FIG. 8, the crust portion 120 may be elevated with respect to the sheet portion 118, and may have a thickness T₂ (FIG. 8) that is different (e.g., greater) than the thickness T₁ of the sheet portion 118, thereby defining the sheet portion 118 as a recess or depression 122 for receiving the toppings 104. In another aspect, as best shown in FIG. 9, the crust portion 120 adjacent to the endpoint 124 of the first and second straight edges 112, 114 may be elevated with respect to the rest of the crust portion 120 on the first and second straight edges 112, 114. Those skilled in the art will appreciate that the crust portion 120 may be elevated by increasing the quantity of dough at the crust portion 120, thereby yielding a thicker crust portion 120 and a thinner sheet portion 118, as shown in FIGS. 8 and 9. Alternatively, the crust portion 120 of the dough substrate 102 may be manipulated such that the crust portion 120 extends upward from, and therefore is raised relative to, the sheet portion 118. In yet another aspect, the crust portion 120 may be generally level with the sheet portion 118 (i.e., T₁=T₂), similar to a Sicilian or Chicago style pizza. In yet another aspect, the crust portion 120 may have a thickness T₂ that is less than the thickness T₁ of the sheet portion 118, and may be marketable as a reduced carbohydrate pizza.

The sheet portion 118 and the crust portion 120 of the dough substrate 102 may be formed using the disclosed assembly 50 (FIG. 3) having a die 56 with an appropriately shaped mold cavity 60 (FIG. 4). For example, referring to FIG. 4, the mold cavity 60 may include a recess 68 for forming the crust portion 120, surfaces 70A, 70B, 70C, 70D for forming the sheet portion 118 and elevated ridges 72A, 72B, 72C, 72D for forming the cut lines 108A, 108B, 108C, 108D. By appropriately changing the shape of the mold cavity 60, the amount of crust portion 120 that extends inwardly along the first and second straight edges 112, 114 of each piece 106 of the pizza 100 may be varied. However, those skilled in the art will appreciate that the dough substrate 102 may be formed using various techniques, such as by hand forming the dough substrate 102, using a hand-operated mold or the like.

Accordingly, after the pizza 100 has been assembled and, optionally, baked to the desired consistency, a cutting device, such as a knife or rolling pizza cutter, may be used to separate the pizza 100 into individual pieces 106, wherein each piece 106 includes toppings 104 and a crust 120 along substantially the entire curved edge 116 of the perimeter 110 and a crust 120 along at least a part of the first and second straight edges 112, 114 of the perimeter 110. The pre-formed cut lines 108A, 108B, 108C, 108D may assist the user in separating the pizza 100 into individual pieces 106.

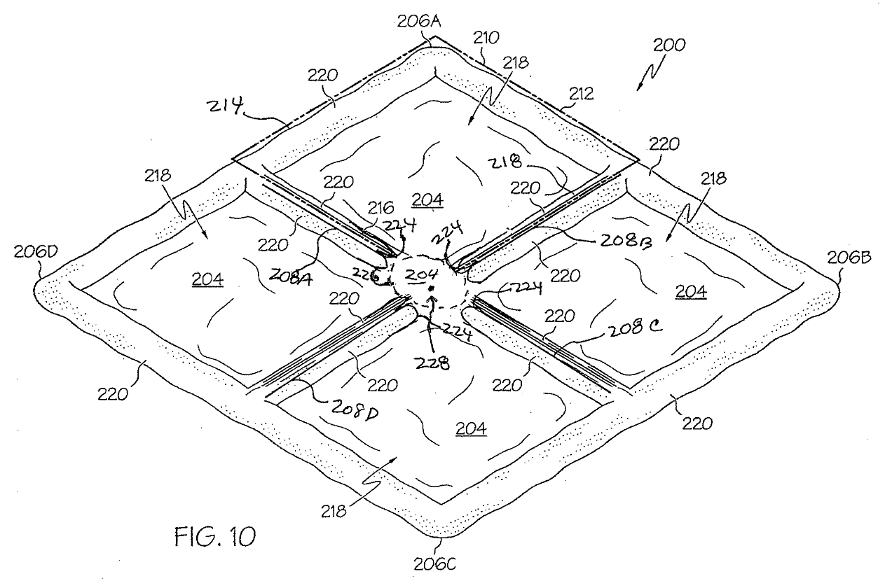

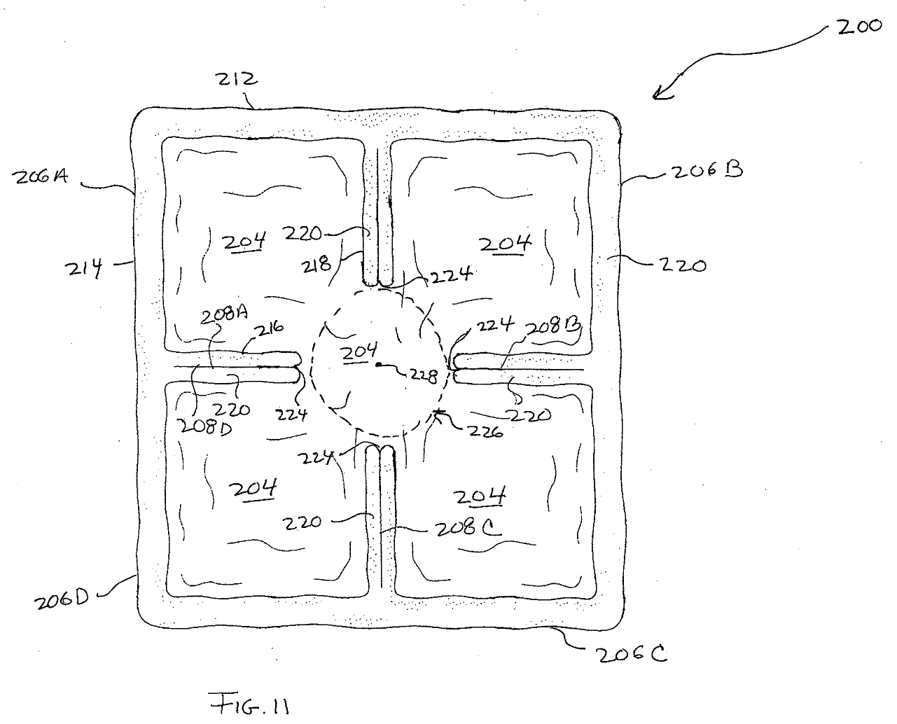

Referring to FIGS. 10 and 11, another aspect of the disclosed pizza, generally designated 200, may include a pizza dough substrate 202 and one or more toppings 204. The dough substrate 202 may be generally square-shaped in top view and may define four segments or pieces 206A, 206B, 206C, 206D (collectively, pieces 206). A center point 228 of the dough substrate 202 is defined as the point where two perpendicular lines drawn through the center of the dough substrate 202 intersect. Again, the number of pieces 206 is purely a matter of design. Each of the pieces 206 may be at least partially defined by pre-formed cut lines 208A, 208B, 208C, 208D. However, as discussed above, absent pre-formed cut lines, the pieces 206 may be at least partially defined by the crust portion 220. Alternatively, the pieces 206 may be defined by actual cuts in the pizza 200.

Referring to FIG. 10, and using piece 206A as an example, each piece 206 has a defined perimeter 210, which is shown as a solid, bold outline about the periphery of piece 206A. Since the pizza 200 is generally square-shaped in top view and since the dough substrate 102 defines generally square-shaped pieces 206, the perimeter 210 of piece 206A includes two exterior edges, shown as a first exterior straight edge 212 and a second exterior straight edge 214; and two interior edges, shown as a first interior straight edge 216 and a second interior straight edge 218.

As discussed above, each piece 206 defined by the dough substrate 202 may include a sheet portion 218 and a crust portion 220. The crust portion 220 may extend substantially entirely along the first and second exterior straight edges 212, 214 of the perimeter 210 of each piece 206. However, those skilled in the art will appreciate that only portions of the exterior edges 212, 214 may include the crust portion 220. The crust portion 220 along each of the first and second exterior straight edges 212, 214 may further extend inwardly along at least a portion of the first and second interior straight edges 216, 218 of each piece 206. The point at which the crust portion 220 ends along the first and second interior straight edges 216, 218 defines an endpoint 224 of the crust portion 220 (FIG. 11). The end point 224 may be at the center point 228 or at a location somewhere between the end point 224 and the exterior edges 212, 214.

In other words, each piece 206A, 206B, 206C, 206D may include a crust portion 220 along at least a portion of the first and second exterior straight edges 212, 214 and along at least a portion of the first and second interior straight edges 216, 218. Optionally, the crust portion 220 adjacent to the endpoint 224 may be elevated with respect to the rest of the crust portion 220.

In one aspect, the length of the crust portion 220 on the first and second interior straight edges 216, 218 is less than the length of a line drawn from either the first or second exterior straight edges 212, 214 to the center point 228 of the dough substrate 202. As best shown in FIG. 11, a central region 226 of the dough substrate 202 adjacent to the center point 228 of the dough substrate 202 may be substantially free of the crust portion 220. As discussed above, the size of the central region 226 adjacent to the center point 228 of the dough substrate 202 may be varied by changing the shape of the mold cavity 60 of the disclosed assembly 50 (FIG. 3), which in turn changes the length of the crust portion 220 along the first and second interior edges 216, 218 of each piece 206.

Thus, as shown in FIGS. 10 and 11, the sheet portion 218 may receive the toppings 204 and the crust portion 220 may at least partially surround the perimeter 210 of each piece of the pizza 200 such that, when the pizza 200 is separated into individual pieces 206A, 206B, 206C, 206D, each piece 206 includes toppings 204 and a crust portion 220 around at least a portion of the first and second exterior straight edges 212, 214 of the perimeter 210 and a crust portion 220 around at least a portion of the first and second interior straight edges 216, 218 of the perimeter 210.

At this point, those skilled in the art will appreciate that pizzas of various shapes and sizes, and having various flavors and textures, may be prepared without departing from the scope of the present disclosure. For example, the pizza could be sold without toppings such that the pizza can be assembled at home.

Although various aspects of the disclosed pizza and associated methods and apparatus for forming the same have been shown and described, modifications may occur to those skilled in the art upon reading the specification. The present patent application includes such modifications and is limited only by the scope of the claims.

What is claimed is:

1. A pizza comprising:
a dough substrate defining a plurality of pieces wherein each piece of said plurality of pieces defines a perimeter and includes a sheet portion and a crust portion, said perimeter comprising at least one exterior edge and at least two interior edges, wherein at least a portion of each of said exterior and interior edges include said crust portion; and
at least one topping positioned on said dough substrate.

2. The pizza of claim 1 wherein said exterior edge is curved and said interior edges are straight.

3. The pizza of claim 1 wherein said dough substrate defines a center point, and wherein a central region adjacent to said center point is substantially free of said crust portion.

4. The pizza of claim 3 wherein a length of said crust portion associated with said interior edges is less than a length of a line drawn from said exterior edge to said center point.

5. The pizza of claim 1 wherein said plurality of pieces of said dough substrate are defined by actual cut lines.

6. The pizza of claim 1 wherein said plurality of pieces of said dough substrate are defined by said crust portion.

7. The pizza of claim 1 wherein said plurality of pieces of said dough substrate are defined by pre-formed cut lines.

8. The pizza of claim 1 wherein said topping is received on said sheet portion of each piece of said plurality of pieces.

9. The pizza of claim 1 wherein said crust portion is substantially free of said topping.

10. The pizza of claim 1 wherein said sheet portion has a first thickness and said crust portion has a second thickness, said second thickness being different than said first thickness.

11. The pizza of claim 1 wherein said sheet portion is generally flat.

12. The pizza of claim 1 wherein said dough substrate is substantially round in top view, and wherein each piece of said plurality of pieces is substantially pie-shaped.

13. The pizza of claim 1 wherein said dough substrate is substantially square in top view, and wherein each piece of said plurality of pieces is substantially square-shaped.

14. The pizza of claim 1 wherein said topping includes at least one of a sauce, a cheese, a meat, a seafood and a produce.

15. The pizza of claim 1 wherein said dough substrate is formed from a dough that has been baked for an amount of time sufficient to alter a texture of said dough.

16. A pizza comprising:
a dough substrate defining a plurality of pieces, each piece of said plurality of pieces including a sheet portion bounded by at least two internal edges and at least one external edge, wherein at least a portion of each of said internal and external edges includes a crust portion, said crust portion having a thickness that is different than a thickness of said sheet portion

17. The pizza of claim 16 further comprising at least one topping disposed on said sheet portion.

18. The pizza of claim 16 wherein each piece of said plurality of pieces radiates from a center point, said center point defining a central region of said dough substrate, and wherein portions of said internal edges within said central region are substantially free of said crust portion.

19. The pizza of claim 18 wherein said central region extends outward from said center point by a radial distance, said radial distance being about 5 to about 50 percent of a distance between said center point and said external edge.

20. The pizza of claim 18 wherein said crust portion on said internal edges extends from said central region to said external edge.

21. The pizza of claim 16 wherein said crust portion extends substantially entirely along said external edge, but only along a portion of each of said internal edges.
